(19) United States
(12) Patent Application Publication
(10) Pub. No.: US 2008/0163570 A1
(43) Pub. Date: Jul. 10, 2008

(54) Glass-Darkening System Which is Suitable For Windows and Similar

(76) Inventors: Daniel Matoses Vercher, Sueca (Valencia) (ES); David Munoz Munoz, Valencia (ES)

Correspondence Address: WENDEROTH, LIND & PONACK, L.L.P., 2033 K STREET N. W., SUITE 800, WASHINGTON, DC, 20006-1021, US

(21) Appl. No.: 11/666,226

(22) PCT Filed: Oct. 24, 2005
(86) PCT No.: PCT/ES05/00567

§ 371 Date: Dec. 5, 2007

(30) Foreign Application Priority Data
Oct. 25, 2004 (ES) P200402544

(51) Int. Cl. E06B 7/00

(52) U.S. Cl. 52/171.3

(57) ABSTRACT

The invention relates to a glass-darkening system comprising a fluid-pumping device which can fill and empty an internal chamber between two transparent glass panes or pane segments belonging to a glazed structure. According to the invention, when the chamber fills with fluid, the glazed structure darkens and, when the chamber empties, the structure becomes transparent once again.

### OBJECT OF THE INVENTION

As stated in the title of this specification, the present invention relates to a glass-darkening system applicable to windows and similar by means of a material which will be located in a narrow chamber between pairs of panes, such that this narrow chamber will be able to be filled with the respective material, darkening the window, or the chamber can be emptied so that light can pass and the transparency that was lost is recovered.

The filling and emptying will be carried out using suitable means.

Moreover, the material used will preferably be a simple or compound fluid, though it could also consist of other materials, such as sand or similar.

With the system of the invention, the use of curtains and blinds is obviated, simplifying the structures currently provided, at both the constructional and the aesthetic levels, which will help to reduce the price of certain installations and/or provide windows, doors, etc., which do not have the possibility of using blinds in order to minimise the passage of light.

So, the objective of the invention is a simple system for darkening glazed surfaces reversibly as many times as is wished, replacing the classical systems of blinds or curtains, as already stated.

It is applicable to windows, shop fronts, partially or wholly glazed doors, etc.

### PRIOR ART OF THE INVENTION

In order to avoid the entry of light, windows currently use curtains and blinds of different kinds, the first being arranged inside the home and the latter via the outside thereof.

### DESCRIPTION OF THE INVENTION

The glass-darkening system applicable to windows and similar is characterised in that, by using a suitable fluid, it is able to fill and empty at least one narrow chamber between a pair of panes, or portions of panes, close to each other.

The filling and emptying will be done by means of independent pumping equipment which incorporates among its elements at least one impeller pump, a tank for the fluid, and a tubular portion which will plug into a valve fixed to the structure or frame of the window in order to permit the filling and emptying of the narrow chamber with the aim of darkening the window or leaving it free to permit the passage of light and be able to see outside from inside the home.

Moreover, the window preferably comprises a frame which supports a laminar structure of panes which generate at least two internal chambers, with at least one of them being sealed, specifically the one on the outer side, with this latter chamber performing the functions of insulating and protecting the other chamber of the pair located on the inner side.

It is precisely this latter, more internal, chamber that will be the one that is flooded with fluid with a high surface tension and low transmittance.

The valve permits connection and disconnection to the tank indefinitely, as many times as is wished.

Likewise, the tank can be inserted in the actual structure of the window, door, shop front, etc.

The return of the liquid to the tank gives the glazed structure back the transparency it has lost and can be done by simple gravity or assisted by means of the impeller pump itself.

The possibility also exists of the chamber that is filled with fluid being partially distributed over the glazed surface, thereby achieving the darkening of just certain zones.

The advantages provided by the system of the invention are, among others, the following:
Reduction in the cost of construction due to the elimination of blinds.
Easy to clean.
Multitude of colours, with the possibility of changing them according to the taste of the consumer.
Production not high.
Acoustic reduction.
Possibility of variations in the production (strengthened glass, mirrors, tinted glass, plastic materials, wood, iron, etc.).
Multitude of profiles (wood, iron, aluminium, plastics, etc.), products cited above, permitting a large variety of thicknesses.

Moreover, the fluid is a self-cleaning liquid owing to its high surface tension and it leaves no trace behind precisely because of that high surface tension.

The fluid can consist, for example, of water, an organic pigment and a viscous element, all this producing a fluid with a high surface tension in order thereby not to leave any trace on the panes when the internal chamber is emptied.

Below, in order to facilitate a better understanding of this specification and forming an integral part thereof, some figures are attached representing the object of the invention.

### BRIEF DESCRIPTION OF THE DRAWINGS

FIG. 1.—Shows a perspective view of a window forming part of the glass-darkening system, the object of the invention.

FIG. 2.—Shows a view in cross-section of the window forming part of the system.

FIG. 3.—Shows a schematic view of the system of the invention including pumping equipment for a fluid for darkening windows and similar by filling a chamber between two pairs of panes close to each other, or a pair of portions of panes.

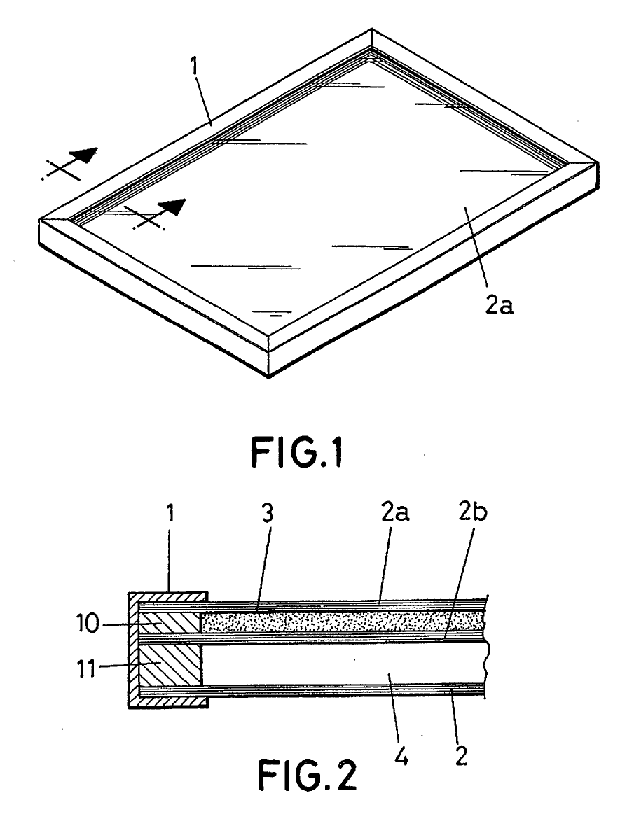

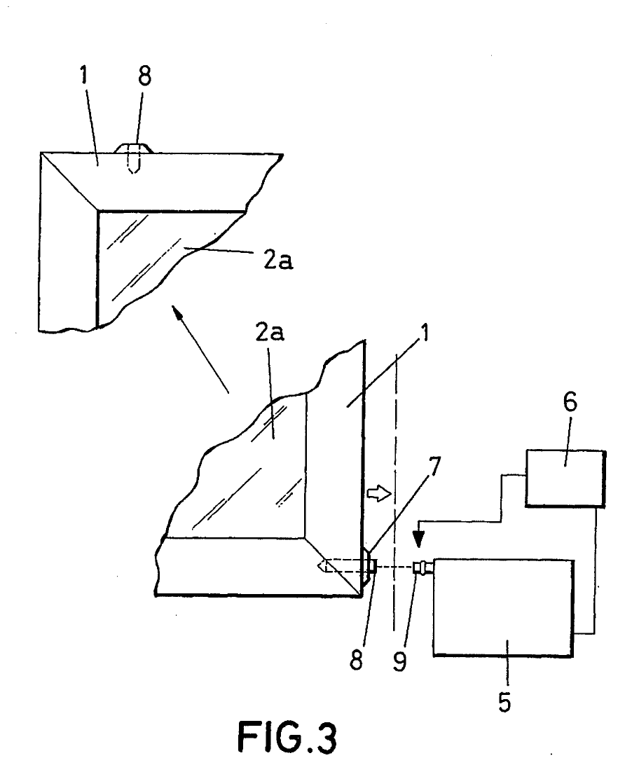

### DESCRIPTION OF THE PREFERRED FORM OF EMBODIMENT

Considering the numbering adopted in the figures, the invention provides for a laminar structure of panes, 2, 2a and 2b, which generate at least two chambers, an internal one 3 and another external one 4, with at least one of them, specifically the external one 4, being sealed, which will perform the functions of protecting and insulating the more internal chamber 3.

Said chamber 3 is the one that is flooded with a high surface tension and low transmittance liquid.

This liquid is stored in a tank 5 which is connected to a valve 7 and impelled by a pump 6 towards the inside of the said internal chamber 3. The connection is made by means of a short tubular portion 9 which plugs into a complementary opening 8 in the valve 7, which is fixed to the frame 1 in correspondence with the internal chamber 3. The said tubular portion 9 starts from the tank 5.

In the case of a window, the valve 7 permits the connection/disconnection to the tank 5 indefinitely, as many times as is desired or required.

Likewise, the tank can be inserted in the actual structure 1 of the window, door, shop front, etc.

Moreover, the return of the fluid to the tank gives back to the glass structure the transparency it had lost and can be carried out by simple gravity or assisted by the actual impeller pump 6.

The panes are separated from each other by some narrow profiles 10 and 11 which determine the width of the two chambers 3 and 4.

1. GLASS-DARKENING SYSTEM WHICH IS SUITABLE FOR WINDOWS AND SIMILAR, which, being intended to darken a glazed structure and/or return the transparency lost when so desired, is characterised in that it comprises a fluid-pumping device which is suitable for filling and emptying at least one internal chamber between two transparent laminar bodies of the glazed structure, all this in order to darken the glazed structure or recover the transparency it has lost.

2. GLASS-DARKENING SYSTEM WHICH IS SUITABLE FOR WINDOWS AND SIMILAR, according to claim 1, characterised in that the glazed structure comprises at least two chambers, an internal one (3) and another external one (4), with at least one of them, the external one (4), being sealed, while the internal one (3) will be the one that is flooded with a high surface tension and low transmittance liquid.

3. GLASS-DARKENING SYSTEM WHICH IS SUITABLE FOR WINDOWS AND SIMILAR, according to claim 1, characterised in that the pumping equipment is an independent unit that includes a male tubular portion (9) which can be plugged into a hole (8) of a valve (7) fixed to the frame (1) of the glazed structure, the respective internal chamber (3) being filled and emptied via that valve (7).

4. GLASS-DARKENING SYSTEM WHICH IS SUITABLE FOR WINDOWS AND SIMILAR, according to claim 1, characterised in that the internal chamber (3) is emptied by gravity.

5. GLASS-DARKENING SYSTEM WHICH IS SUITABLE FOR WINDOWS AND SIMILAR, according to claim 2, characterised in that the pumping equipment is an independent unit that includes a male tubular portion (9) which can be plugged into a hole (8) of a valve (7) fixed to the frame (1) of the glazed structure, the respective internal chamber (3) being filled and emptied via that valve (7).

6. GLASS-DARKENING SYSTEM WHICH IS SUITABLE FOR WINDOWS AND SIMILAR, according to claim 2, characterised in that the internal chamber (3) is emptied by gravity.

7. GLASS-DARKENING SYSTEM WHICH IS SUITABLE FOR WINDOWS AND SIMILAR, according to claim 3, characterised in that the internal chamber (3) is emptied by gravity.
